(19) United States
(12) Patent Application Publication
(10) Pub. No.: US 2023/0381710 A1
(43) Pub. Date: Nov. 30, 2023

(54) A SYSTEM AND A METHOD FOR A 24X7 SOLAR THERMAL-BASED ATMOSPHERIC WATER GENERATOR USING DESICCANTS

(71) Applicant: URAVU LABS PRIVATE LIMITED, Karnataka (IN)

(72) Inventors: Govinda Balaji BALAKRISHNAN, Tamil Nadu (IN); Pardeep GARG, Karnataka (IN); Swapnil Sangeet SHRIVASTAV, Gujarat (IN); Venkatesh RAJA, Tamil Nadu (IN)

(21) Appl. No.: 18/248,239

(22) PCT Filed: Oct. 8, 2021
(86) PCT No.: PCT/IN2021/050971

§ 371 Date: Apr. 6, 2023

(30) Foreign Application Priority Data
Oct. 8, 2020 (IN) 202041028007

(51) Int. Cl. B01D 53/04; E03B 3/28; B01D 53/26

(52) U.S. Cl. CPC B01D 53/0438; E03B 3/28; B01D 53/265

(57) ABSTRACT

The present invention relates to a field of atmospheric water generator systems and more particularly to an atmospheric water generator system (100) comprising: a solar heat unit (110) configured to receive solar radiation during solar hours and convert the received solar radiation (300) into heat, a thermal storage unit (120) configured to receive the heat from the solar heat unit (110) during solar hours and store the received heat, a desiccant unit (130) comprising a desiccant material (131), and configured to receive the heat from the thermal storage unit (120) or the solar heat unit (110), wherein the desiccant unit (130) is configured to undergo an adsorption mode (150) to adsorb air from the atmosphere and a desorption mode (160) to recover water vapor from the desiccant material (131) and a condenser unit (140) configured to receive and facilitate condensation of water vapor and generate fresh water (205) and wherein the solar heat unit (110) and the desiccant unit (130) are in fluidic communication with each other.

### FIELD OF THE INVENTION

The present invention relates to a field of atmospheric water generator systems and more particularly to an apparatus and system for the production of potable freshwater from atmospheric air using solar thermal energy in a scalable and affordable manner.

### BACKGROUND OF THE INVENTION

At any given moment the earth contains 326 million cubic miles of water and of this, 97% is salt water and only 3% is freshwater. Of the 3% that is freshwater, 70% is frozen in Antarctica and of the remaining 30% only 0.7% is found in liquid form. Atmospheric air contains 0.16% of this 0.7% or 4,000 cubic miles of water which is 8 times the amount of water found in all the rivers of the world. Of the remaining 0.7%, 0.16% is found in the atmosphere, 0.8% is found in soil moisture, 1.4% is found in lakes and 97.5% is found in groundwater.

Nature maintains this ratio by accelerating or retarding the rates of evaporation and condensation, irrespective of the activities of man. Such evaporation and condensation is the means of regenerating wholesome water for all forms of life on earth. In addition, many of the world's freshwater sources are contaminated. Currently, 1.2 billion people have no access to safe and high quality drinking water and that number is increasing steadily, with forecasts of a potential 2.3 billion (or one-third of the earth's population) without access to safe water by 2025 (World Health Organization's statistics from World Commission on Water for the 21st Century). “Millions of poor urban dwellers have been left without water supply and sanitation in the rapidly growing cities of the developing world. According to the United Nations, 31 countries in the world are currently facing water stress and over one billion people lack access to clean water. Half of humanity lacks basic sanitation services and water-borne pathogens kill 25 million people every year. Every 8 seconds, a child dies from drinking contaminated water. Furthermore, unless dramatic changes occur, soon, close to two-thirds of the world's population will be living with freshwater shortages.

Potable freshwater is a shrinking resource around the world. It is in short supply in many parts of the world, and in the future, it will become even more challenging to supply the water requirements of growing populations. Climate change effects have begun to alter expected weather and water patterns, and these changes, combined with an ever-increasing human population and increased water requirements for domestic, agriculture and industrial sectors has led and will lead to shortages.

The industrial sector's water consumption is increasing, accounting for 8.5 and 10.1 percent of total freshwater abstraction in 2025 and 2050, respectively. This is a 4% increase from the 6% of total freshwater abstraction by industry back in 2010. Water concerns can be complicated, and they can have a variety of consequences for water users, including FMCG enterprises. The dangers are divided into three categories: physical concerns associated with water shortages, which can disrupt direct activities or cause supply chain disruptions; reputational risks; and regulatory risks. The natural capital cost of water use in Asia is $1.15 trillion dollars. This takes into account local water availability to provide a more accurate water pricing, as well as the unpaid and unpriced natural capital input to industry. This is a large amount of money on the line in Asia, and it accounts for half of all unpaid expenditures (or risks) worldwide. Asia is therefore facing by far the largest risk of any region. By analysing different areas of Asia using WWF's Water Risk Filter we can see that India and China face particular threats. Sixty-eight percent of FMCG respondents in a survey said they were exposed to hazards in direct operations and supply chains. Increased water shortage, increased water stress, and drought were the most major risk drivers identified. Around 14% of those surveyed believe that environmental changes in recent decades have had an impact on freshwater supply. Freshwater species are disappearing at a higher rate than any other type of species. This has an influence on the livelihoods of those who rely on them as well as the health of the ecosystem. For any organisation, especially one that relies on agricultural goods, the value of the services offered by freshwater ecosystems is extremely high. Seventy-five percent of FMCG respondents said they have considered how water hazards would affect their company's growth in the foreseeable future. Physical restrictions to expansion, as well as limits to getting a social licence to grow and operate, are examples of such restraints. If water resources are not factored into long-term planning, they may become a limiting issue for expansion.

As is known, for production of potable water, in places where the water supply sources are poor or difficult to reach, apparatus are used for obtaining a quantity of water, for example potable water, from de-humidification of the atmospheric air. There are over 3 quadrillion gallons of water in the atmosphere which can be tapped to source freshwater. The atmospheric air typically contains moisture and the amount of water in atmospheric air varies with temperature and pressure. Hot humid air contains more water than cold dry air. Moisture contained in atmospheric air condenses into liquid form as droplets when the air temperature drops below a determined dew point. The systems for converting atmospheric moisture into potable freshwater have existed for decades. However, widespread consumer acceptance of such systems is still lacking, largely due to their operational inefficiencies, noise, concerns with cleanliness, and a general lack of user engagement.

Most of the prior art is based on simply extracting some water from the air in an uncontrolled mode, but with little concern for efficiency. Since the known atmospheric water harvesters work on electricity and per litre cost of water produced available in the market is costly (i.e. 2-6 INR). The devices are not modular and perform poorly in low humid environment conditions thus remain unviable for such locations.

The water extraction devices which exist in the market are expensive, inefficient, bulky, and noisy and have low moisture extraction rates. This, coupled with high costs, has led to lower adoption and acceptance of this technology. The electricity based water harvesters can be coupled with a Solar PV system for an off grid installation, but the complexity of the devices ensures a high capital cost for panels, batteries and inverters coupled with an intensive maintenance program. Further, in the current water infrastructure the grid is too centralized in nature, and will not be able to serve a lot of areas and population zones. Especially in locations out of grid reach might not be able to meet the future demand of increasing population. There is a dire need for cost-effective and scalable alternative technologies to source freshwater. There is a need for an improved atmospheric water generator system which produces cleaner water at most temperatures and humidity levels more efficiently, includes convenient noise and energy control functionality, all while engaging the user in a manner that ensures their continued use of the machine. Currently, there are not many systems to control the unit in real time i.e. remote monitoring.

Therefore, there is a need in the art of an atmospheric water generator system to solve the above-mentioned limitations.

### SUMMARY OF THE INVENTION

An aspect of the present invention is to address at least the above-mentioned problems and/or disadvantages and to provide at least the advantages described below.

Accordingly, in one aspect of the present invention relates to an atmospheric water generator system (100) comprising: a solar heat unit (110) configured to receive solar radiation during solar hours and convert the received solar radiation (300) into heat, a thermal storage unit (120) configured to receive the heat from the solar heat unit (110) during solar hours and store the received heat, a desiccant unit (130) comprising a desiccant material (131), and configured to receive the heat from the thermal storage unit (120) or the solar heat unit (110), wherein the desiccant unit is configured to undergo an adsorption mode (150) to adsorb air from the atmosphere and a desorption mode (160) to recover water vapor from humidity in adsorbed air; and a condenser unit (140) configured to receive and facilitate condensation of water vapor and generate freshwater and wherein the solar heat unit (110) and the desiccant unit (130) are in fluidic communication with each other.

Another aspect of the present invention relates to a method (1300) of generating water from air using solar energy, the method comprising: receiving, by a solar heat unit (110), a solar radiation during solar hours and converting the received solar radiation into heat (1310), receiving, by a thermal storage unit (120), the heat from the solar heat unit during solar hours and storing the received heat (1320), receiving, by a desiccant unit (130), the heat from the thermal storage unit or the solar heat unit, where the desiccant unit (130) comprises a desiccant material which undergo an adsorption mode (150) to adsorb air from the atmosphere and a desorption mode (160) to recover water vapor from humidity in adsorbed air (1330) and receiving, by a condenser unit (140), the water vapour and facilitating condensation of water vapor and generating fresh water (1340), facilitating a fluidic communication between the solar heat unit (110) and the desiccant unit (130).

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings in which:

FIG. 1 shows the block diagram of a system comprising a solar heat unit, a thermal storage unit, a desiccant unit, and a condensing unit.

FIG. 2 shows the block diagram of a system comprising a solar heat unit, a thermal storage unit further comprising a hot storage unit and a cold storage unit, a desiccant unit further comprising an adsorption section and a desorption section, and a condensing unit.

FIG. 3 shows the block diagram of a system comprising a solar heat unit, a thermal storage unit further comprising a hot storage unit and a cold storage unit, a desiccant unit further comprising a desiccant holder and a desiccant heating element, and a condensing unit.

FIG. 4 (a & b) shows the block diagram of a system comprising a solar heat unit, a thermal storage unit further comprising a hot storage unit and a cold storage unit, two desiccant units namely a first desiccant unit and a second desiccant unit both further comprising a desiccant holder and a desiccant heating element, and a condensing unit.

FIG. 5 shows the block diagram of condenser unit of the desiccant-based and a solar thermal-based atmospheric water generator system, with the mineralising unit according to one embodiment of the present invention.

FIG. 6 shows the block diagram of the solar heat unit of the desiccant-based and a solar thermal-based atmospheric water generator system with additional reflective elements in the solar heat unit according to one embodiment of the present invention.

FIG. 7 shows the block diagram of the desiccant unit of the desiccant-based and a solar thermal-based atmospheric water generator system with valves according to one embodiment of the present invention.

FIG. 8 shows the block diagram of the desiccant unit and condenser unit of the desiccant-based and a solar thermal-based atmospheric water generator system connected with the fans wherein electricity is supplied by photovoltaic cells and battery storage according to one embodiment of the present invention.

FIG. 9 shows the block diagram of the desiccant unit and condenser unit of the desiccant-based and a solar thermal-based atmospheric water generator system connected with valves according to one embodiment of the present invention.

FIG. 10 shows the block diagram of the condenser unit of the desiccant-based and a solar thermal-based atmospheric water generator system integrated with the filtration unit according to one embodiment of the present invention.

FIG. 11 shows the block diagram of the desiccant unit of the desiccant-based and a solar thermal-based atmospheric water generator system integrated with the air filtration unit according to one embodiment of the present invention.

FIG. 12 shows the block diagram of the solar heat unit and thermal storage unit of the desiccant-based and a solar thermal-based atmospheric water generator system connected to each other with the pumps according to one embodiment of the present invention.

FIG. 13 shows a method of generating water from air using solar energy according to one embodiment of the present invention.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure.

Throughout the drawings, it should be noted that reference numbers are used to depict the same or similar elements, features, and structures.

### DETAILED DESCRIPTION OF THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including, for example, tolerances, measurement error, measurement accuracy limitations and other factors known to those of skill in the art, may occur in amounts that do not preclude the effect the characteristic is intended to provide.

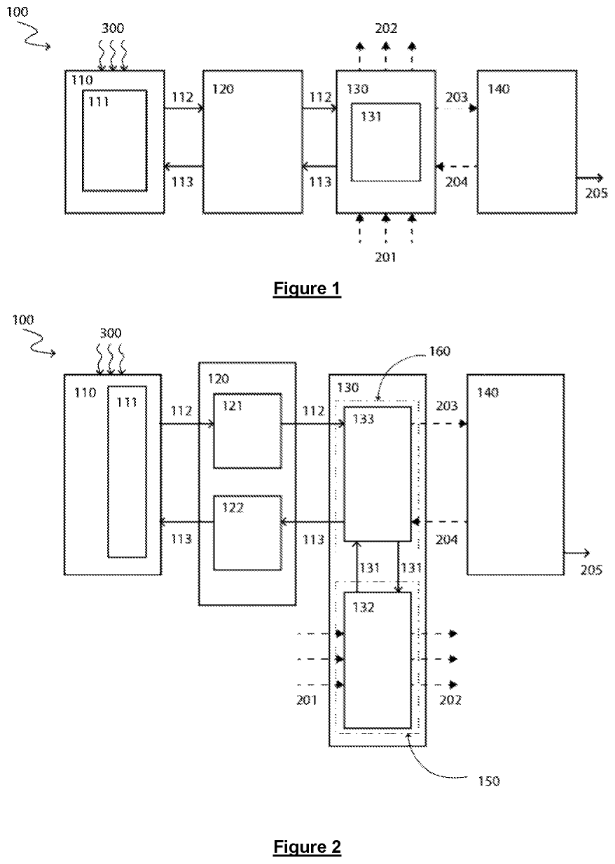

FIGS. 1 through 13, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description and that their use and definitions, in no way limit the scope of the invention. Terms first, second, and the like are used to differentiate between objects having the same terminology and are in no way intended to represent a chronological order, unless where explicitly stated otherwise. A set is defined as a non-empty set including at least one element.

In the following description, for the purpose of explanation, specific details are set forth in order to provide an understanding of the present disclosure. It will be apparent, however, to one skilled in the art that the present disclosure may be practiced without these details. One skilled in the art will recognize that embodiments of the present disclosure, some of which are described below, may be incorporated into a number of systems.

However, the systems and methods are not limited to the specific embodiments described herein. Further, structures and devices shown in the figures are illustrative of exemplary embodiments of the presently disclosure/invention and are meant to avoid obscuring of the presently disclosure/invention.

Any atmospheric water generator system in the prior art using desiccants to produce water and using solar heat comprises two key elements, namely, a solar heat unit and a desiccant unit. In the prior art, both of these components, the solar heat element, and the desiccant unit are configured to be not only in the fluidic communication with each other but also in the physical communication with each other. This limits the maximum size of the system (in terms of liters per day) built on this approach and thus the system tends to become non-scalable in nature. For example, if both the components, the solar heat unit and the desiccant unit are physically integrated with each other, then constraints like panel span of the solar heat unit and the overall weight of the system limit the maximum water generation capacity on a per day basis. Generally, this approach limits water generation to about 5-20 liters per day for a single system. If the application case demands higher water generation than 20 liters per day, then one would need to install many of such systems to meet the desired demand. This is merely a duplication of the systems without any synergy. The physical communication between the solar heat unit and the desiccant unit hinders us from exploiting principles of economies of scale when we size up the solar thermal-based atmospheric water generation using desiccants.

The present invention reveals an approach that is to configure the solar heat operated atmospheric water generator system in such a way that the solar heat unit and the desiccant unit are only in fluidic communication with each other but not in the physical communication with each other. Such systems are highly scalable in terms of liters per day of water generation. Since the solar heat unit and the desiccant unit are not in physical communication with each other, the solar heat unit and the desiccant unit can independently and linearly be scaled up to build systems of capacities much beyond 20 liters per day. With this approach, it is feasible to build desiccant and solar thermal-based atmospheric water generation systems that have principles of economies of scale embedded in their foundations. The embodiments built on this invention produce water at a much lower and affordable cost on a per liter basis, as the system is easily scaled up. The present invention reveals embodiments that facilitate generation of water from air using solar heat and using desiccants in a cost-effective way at scales as high as millions of liters of water per day.

Further, the prior art on the desiccant-based atmospheric water generator systems using solar heat reveals that water from air is produced only during solar hours. This is because heat is required as an essential step in the desorption mode and heat intrinsically is available only during solar hours in the solar heat operated systems. This limits the capacity utilization factor of the components used in the atmospheric water generator systems. In practice, the solar thermal-based atmospheric water generator systems using desiccants in the prior art have a capacity utilization factor of not more than 30%. In other words, in the prior art of the desiccant-based and the solar thermal-based atmospheric water generator systems, the desiccant unit, though available for the whole day, is active only during solar hours and remains inactive during non-solar hours. If the desiccant could remain active throughout the day, then less mass of desiccant material would be required in the desiccant unit. This can significantly lower the cost of water generation on a per liter basis.

The present invention first reveals the systems that decouple the solar heat unit and the desiccant unit making the atmospheric water generator system substantially scalable; solving the key problem of scalability that exists with the prior art of the solar thermal-based atmospheric water generator systems using desiccants. This inventive step further facilitates a provision for incorporating a thermal storage unit wherein the thermal storage unit provides the necessary heat to the atmospheric water generator system for carrying out the desorption mode. In one type of embodiment, the thermal storage unit provides heat to the desiccant unit for its desorption mode in the non-solar hours as well. These embodiments facilitate the desiccant material in the desiccant unit to be active in the non-solar hours as well, thus increasing the capacity utilization factor of the desiccant-based solar thermal-based atmospheric water generator systems to near 100%. This inventive step enables higher cost-effectiveness in addition to the system being scalable.

The present invention relates to the desiccant-based and solar thermal-based atmospheric water generator systems and particularly relates to scalable systems and methods for harvesting water from atmospheric air using solar thermal energy in a 24×7 manner. The present system provides a cost-effective and scalable alternative technology to source freshwater in a 100% renewable manner.

The present invention relates to a smart atmospheric water generator system powered by solar thermal energy. The process of harvesting atmospheric water vapor uses the following steps: (a) passing atmospheric air to the desiccant material to capture and store water vapor, (b) heating a heat transfer fluid using solar radiation in a solar heat unit, (c) storing the heat transfer fluid in a thermal storage unit, (d) heating a desiccant material using the heat transfer fluid, (d) condensing released water vapor as freshwater.

The various embodiments of the present invention provide a water generator system using atmospheric air.

FIG. 1 shows the block diagram of a desiccant-based and a solar thermal-based atmospheric water generator system. The system (100) comprises a solar heat unit (110), a thermal storage unit (120), a desiccant unit (130), a condenser unit (140). The solar heat unit (110) is configured to receive radiation (300) from the sun and facilitate heating of a heat transfer fluid (111). The thermal storage unit (120) is configured to store the heat collected by solar heat unit (110). The desiccant unit (130) further comprises a desiccant material (131) that can adsorb water vapor upon cooling and desorb upon heating. The desiccant material (131) can undergo an adsorption mode (150) and a desorption mode (160). During the adsorption mode (150), the desiccant material (131) is in fluidic communication with the atmospheric air (201). A part of humidity in the atmospheric air (201) is captured by the desiccant material (131), when the atmospheric air (201) is passed over the desiccant material (131) owing to its high affinity towards water vapor, while the remaining dehumidified air (202) is released back to the atmosphere. During the desorption mode (160), the desiccant material (131) is heated up using the hot heat transfer fluid (112). The part of the humidity captured over the desiccant material is recovered as water vapor when the desiccant material (131) is heated. The water vapor along with the trapped air (203) in the desiccant unit (130) is circulated to the condenser unit (140) wherein the water vapor is condensed and recovered as freshwater (205) and the return air (204) along with non-condensed water vapor is passed back to the desiccant unit (130) during the desorption mode (160). At any given instance, the desiccant unit (130) is physically detached from the solar heat unit (110). Thus, the solar heat unit (110) and the desiccant unit (130) are not in physical communication. However, the solar heat unit (110) and the desiccant unit (130) are in fluidic communication with each other via heat transfer fluid (111).

In one embodiment, the present invention relates to an atmospheric water generator system (100) comprising: a solar heat unit (110) configured to receive solar radiation during solar hours and convert the received solar radiation (300) into heat, a thermal storage unit (120) configured to receive the heat from the solar heat unit (110) during solar hours and store the received heat, a desiccant unit (130) comprising a desiccant material (131), and configured to receive the heat from the thermal storage unit (120) or the solar heat unit (110), wherein the desiccant unit is configured to undergo an adsorption mode (150) to adsorb air from the atmosphere and a desorption mode (160) to recover water vapor from humidity in adsorbed air and a condenser unit (140) configured to receive and facilitate condensation of water vapor and generate fresh water and wherein the solar heat unit (110) and the desiccant unit (130) are in fluidic communication with each other.

In one embodiment, the present invention relates to a desiccant-based and a solar thermal-based atmospheric water generator system (100) wherein the system is configured to store enough heat in the thermal storage unit (120) to carry out the desorption mode (160) only during the solar hours. The incorporation of the thermal storage unit (120) helps in mitigating the effects of clouds on the system performance. Further, the thermal storage unit (120) is sized to store heat for durations ranging from minutes to hours.

In one embodiment, the desiccant unit (130) comprises at least one actuated element which facilitates establishing and breaking the fluid communication of the desiccant unit with the atmospheric air (201).

In one embodiment, the present invention relates to a desiccant-based and a solar thermal-based atmospheric water generator system (100), wherein the system (100) is configured to store enough heat in the thermal storage unit (120) to carry out the desorption mode (160) for non-solar hours. The heat required to carry out the desorption mode (160) in the non-solar hours is provided by the stored hot heat transfer fluid (112) in the thermal storage unit (120). A plentiful capacity of the thermal storage unit (120) can lead to 24×7 water generation, thus ensuring the desiccant material (131) to be active throughout the day and the night. This increases the capacity utilization factor of the desiccant material (131) to be near 100%.

In one embodiment, the present invention relates to a desiccant-based and a solar thermal-based atmospheric water generator system, wherein the system is configured to comprise a mineralizing unit (400) coupled to the condenser unit (140) for adding essential minerals to the condensed freshwater (205). (FIG. 5)

In one embodiment, the present invention relates to a desiccant-based and a solar thermal-based atmospheric water generator system, wherein the desiccant material (131) is selected from a group consisting of silica-gel, calcium chloride, activated carbon, zeolites, hydrogels, glycols, and metal-organic frameworks.

In one embodiment, the present invention relates to a desiccant-based and a solar thermal-based atmospheric water generator system, wherein the solar heat unit (110) comprises solar heat collectors such as but not limited to evacuated tube collectors, and flat plate collectors. Further, the solar heat unit (110) heats up the heat transfer fluid (111) to a temperature lower than 100° C.

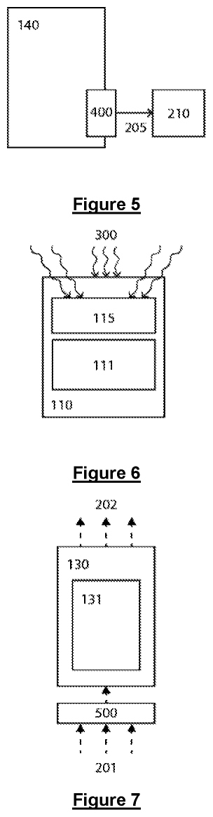

In one embodiment, the present invention relates to a desiccant-based and a solar thermal-based atmospheric water generator system, wherein the solar heat unit (110) comprises a reflecting element (115) to gather additional heat in the heat transfer fluid (111). The reflective element (115) can be configured to provide extra radiation to the solar heat unit (110) in addition to what solar heat unit (110) receives directly from the Sun (300). (FIG. 6)

In one embodiment, the present invention relates to a desiccant-based and a solar thermal-based atmospheric water generator system, wherein the heat transfer fluid (111) is selected from a group consisting of water, air, ethylene glycol, therminols. The heat transfer fluid (111) receives heat from the solar heat unit (110) and gets heated up to a temperature lower than 100° C.

In one embodiment of the system, the system undergoes multiple cycles in a day and said system comprises a thermal storage unit (120) to store the heat transfer fluid (111) which facilitates operation of the system under desorption mode of the system during not only solar hours but also during non-solar hours. The system is configured to undergo as a part or whole through multiple cycles in a day by providing thermal energy from the thermal storage unit (120) during solar hours.

In one embodiment of the system, the system undergoes multiple cycles in a day and said system comprises a thermal storage unit (120) to store the hot heat transfer fluid (112) which facilitates operation of the system under desorption mode (160) of the system during not only solar hours but also during non-solar hours. The system is configured to undergo as a part or whole thru multiple cycles in a day by providing thermal energy from the thermal storage unit (120) during non-solar hours.

In one embodiment of the system, the system undergoes multiple cycles in a day and said system comprises a thermal storage unit (120) to store the heat transfer fluid (111) which facilitates operation of the system under desorption mode (160) of the system during not only solar hours but also during non-solar hours. The system is configured to undergo as a part or whole through multiple cycles in a day by providing thermal energy from the thermal storage unit (120) throughout the day.

In one embodiment of the system, the desiccant heating element (135) in the desiccant unit (130) is configured to receive the hot heat transfer fluid (112) at flow rates wherein the temperature of the cold heat transfer fluid (113) entering the cold storage unit (122) approximates the temperature of desiccant material (131) in the desiccant unit (130) in order to store maximum amount of heat per kilogram of the heat transfer fluid (111) and thus minimize the cost of thermal storage unit (120).

According to one embodiment of the present invention, the system comprises valves (500) to regulate or control fluid exchange between the desiccant unit (130) and the atmospheric air (201). (FIG. 7).

In one embodiment of the system, the system comprises fans (510) to establish fluid communication of the desiccant unit (130) with the condenser unit (140) during the desorption mode (160) of the system. (FIG. 8).

In one embodiment of the system, the desiccant unit (130) comprises metallic or non-metallic box providing support to the desiccant material (131) and the desiccant heating element (135).

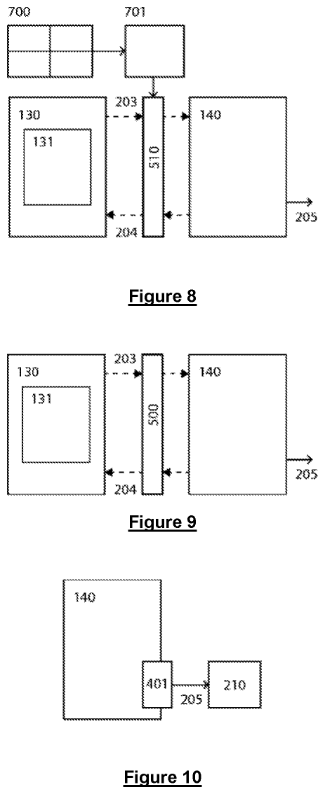

According to one embodiment of the present invention, the system comprises one or more valves (500) to regulate or control fluid exchange between the desiccant unit (130) and the condenser unit (140). (FIG. 9)

In one embodiment of the system, the desiccant holder (134) acts like a fin as well as the desiccant holder.

According to one embodiment of the present invention, the system further comprises the collection unit (210) to collect condensed freshwater (205).

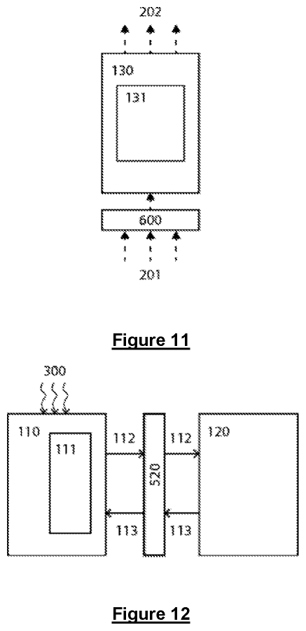

According to one embodiment of the present invention, the system comprises a water filtration unit (401) to remove particle impurities. The water filtration unit (401) comprises but not limited to ultra-filtration membranes, activated charcoal, and ultra-violet lamp. (FIG. 10)

According to one embodiment of the present invention, the system comprises an air-filter unit (600) before the atmospheric air (201) is introduced in the desiccant unit (130) in order to ensure dust-free freshwater collection. (FIG. 11)

In one embodiment of the system, the condenser unit (140) comprises a fin based surface. The condenser unit (140) can be actively or passively cooled in dry mode. The condenser unit (140) can also be configured to undergo wet cooling. Further, the condenser unit (140) is provided with fins to provide heat transfer area for transferring heat from the water-vapor to atmospheric air (201).

According to one embodiment of the present invention, the desiccant unit (130) is configured to remain in fluid communication only till the atmospheric air (201) achieves a maxima in terms of relative humidity during operations the adsorption mode (150) of the system.

According to one embodiment of the present invention, the condenser unit (140) is coated from the inside with a selective coating or a combination of selective coatings ensuring dropwise condensation.

In one embodiment, the present invention relates to a desiccant-based and a solar thermal-based atmospheric water generator system, wherein the thermal storage unit (120) comprises two storage units, namely, a hot storage unit (121) and a cold storage unit (122). In one configuration, the hot heat transfer fluid (112) is stored in the hot storage unit (121). The hot storage unit (121) is configured to supply the hot heat transfer fluid (112) to the desiccant unit (130) for carrying out the desorption mode (160). The hot heat transfer fluid (112) transfers its heat to the desiccant material (131) during the desorption mode (160) and cools down. The cold heat transfer fluid (113) is then transferred to the cold storage unit (122). The cold heat transfer fluid (113) is supplied to the solar heat unit (110) during solar hours for heating up the cold heat transfer fluid (113) using solar radiation of the Sun (300).

In one embodiment, the present invention relates to a desiccant-based and a solar thermal-based atmospheric water generator system, wherein the desiccant unit (130) is in fluidic communication with the solar heat unit (110). The system is configured to circulate the hot heat transfer fluid (112) from the solar heat unit (110) to the desiccant unit (130). The hot heat transfer fluid (112) transfers its heat to the desiccant material (131) during the desorption mode (160) and cools down. The cold heat transfer fluid (113) is then circulated back to the solar heat unit (110) for further heating.

In one embodiment of the system, while the adsorption mode (150) is carried out in non-solar hours of a day, the desorption mode (160) is constrained to solar hours of the day.

In one embodiment of the system, the system is configured to undergo only one adsorption mode (150) and one desorption mode (160). Said configuration is also referred to as a configuration wherein the system is said to undergo a single cycle in a day.

In one embodiment of the system, the system is configured to undergo a plurality of the adsorption modes (150) and the desorption modes (160) followed by each other. Said configuration is also referred to as a configuration wherein the system is said to undergo multiple cycles in a day.

In one embodiment, the present invention relates to a desiccant-based and a solar thermal-based atmospheric water generator system, wherein the thermal storage unit (120) is in fluidic communication with the solar heat unit (110). The system is configured to circulate the hot heat transfer fluid (112) from the thermal storage unit (120) to the desiccant unit (130). The hot heat transfer fluid (112) transfers its heat to the desiccant material (131) during the desorption mode (160) and cools down. The cold heat transfer fluid (113) is then circulated back to the thermal storage unit (120) for collection.

In one embodiment, the present invention relates to a desiccant-based and a solar thermal-based atmospheric water generator system, wherein the desiccant unit (130) is configured to comprise a fan unit (510). The fan unit (510) can further comprise a plurality of fans. These fans ensure forced circulation of the atmospheric air (201) across the desiccant unit (130) during the adsorption mode (150).

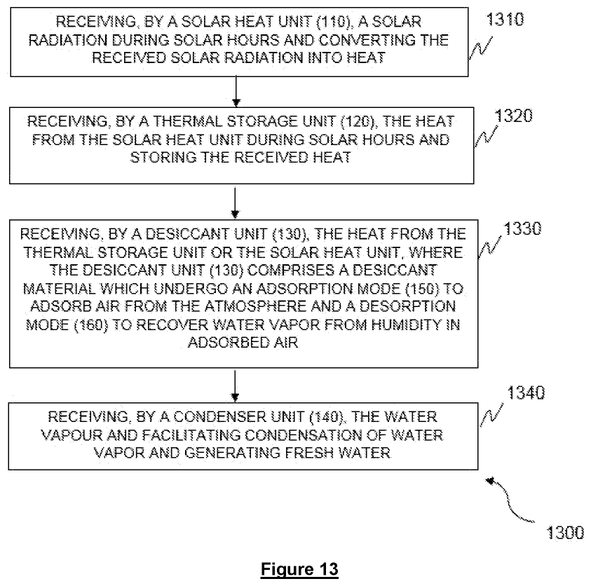

In one embodiment, the present invention relates to a desiccant-based and a solar thermal-based atmospheric water generator system, wherein the system comprises a pump unit (520). The pump unit (520) can further comprise a plurality of pumps. These pumps ensure circulation of the heat transfer fluid (111) to the desiccant unit (130). In one embodiment, pumps are also used to establish fluid communication between the solar heat unit (110) and the thermal storage unit (120), the desiccant unit (130) and the thermal storage unit 120. (FIG. 12)

In one embodiment, the present invention relates to a desiccant-based and a solar thermal-based atmospheric water generator system, wherein the desiccant unit (130) and the condenser unit (140) are in physical communication with each other.

In one embodiment, the present invention relates to a desiccant-based and a solar thermal-based atmospheric water generator system, wherein the desiccant unit (130) and the condenser unit (140) are in fluidic communication with each other.

In one embodiment, the present invention relates to a desiccant-based and a solar thermal-based atmospheric water generator system, wherein the actuating elements such as but not limited to valves, linear actuators are used to continue and discontinue fluidic communication.

In one embodiment, the present invention relates to a desiccant-based and a solar thermal-based atmospheric water generator system, wherein the electricity requirements of the system are met using grid electricity or the on spot power production using photovoltaic cells (700) and battery storage (701). (FIG. 8)

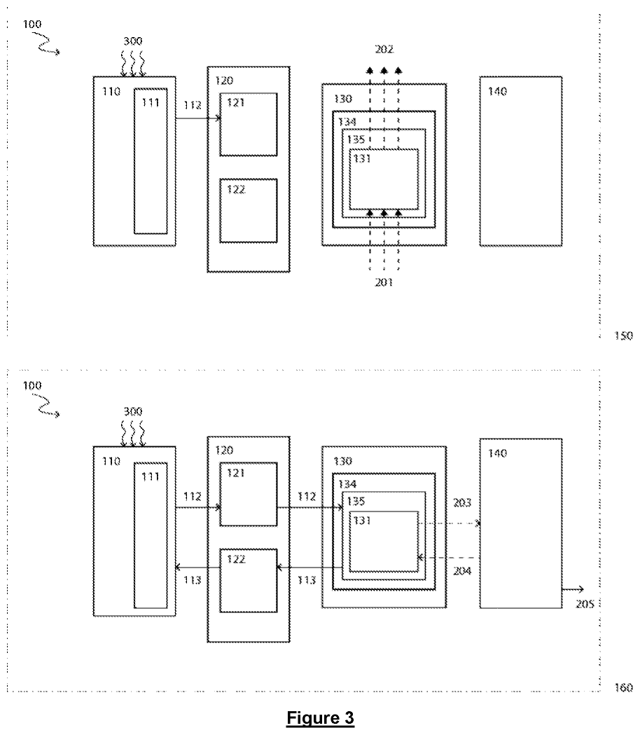

FIG. 2 In one embodiment, the present invention relates to a desiccant-based and a solar thermal-based atmospheric water generator system, wherein the desiccant unit (130) is configured to comprise of two sections, namely an adsorption section (132) and a desorption section (133). The adsorption section (132) is configured to be in fluidic communication with the atmospheric air (201). The desorption section (133) is configured to be in fluidic communication with the solar heat unit (110) or the thermal storage unit (120) for receiving heat transfer fluid (111). The desorption section (133) is also in communication with the condenser unit (140) for condensing the water vapor as freshwater (205). In one embodiment, the adsorption mode (150) and the desorption mode (160) occur simultaneously. In another embodiment, the adsorption mode (150) and the desorption mode (160) occur in a continuous manner. In yet another embodiment, the adsorption mode (150) and the desorption mode (160) occur in a simultaneous and continuous manner.

The solar heat unit (110) is configured to heat up the heat transfer fluid (111) and supply to the thermal storage unit (120) for facilitating the storage of heat. The thermal storage unit (120) is configured to be in fluidic communication between the solar heat unit (110) and the desiccant unit (130). The thermal storage unit (120) comprises the hot storage unit (121) and the cold storage unit (122). The desiccant unit (130) comprises two partitions, namely the adsorption section (132) and the desorption section (133). The hot storage unit (121) supplies the hot heat transfer fluid (112) to the desorption section (133) wherein the desiccant material (131) gets heated up and releases water vapor. The desorption section (133) is in fluidic communication with the condenser unit (140) wherein the water vapor is condensed in the condenser unit (140) and return air (204) is circulated back to the desorption section wherein the return air (204) mixes with the newly formed water vapor in the desorption section (133) and again is fed to the condenser unit (140) completing a closed loop. The adsorption section (132) of the desiccant unit is in fluidic communication with the atmospheric air (201) wherein a part of humidity in the atmospheric air (201) is captured over the desiccant material. Further, the adsorption section (132) and the desorption section (133) are in fluidic communication with each other wherein the desiccant material (131) is circulated between the adsorption section (132) and the desorption section (133) in a closed loop. The use of liquid desiccant is more favorable with the said system configuration as the desiccant material (131) needs to be circulated between the adsorption section (132) and the desorption section (133). The key advantage is that the adsorption mode (150) and the desorption mode (160) can run simultaneously and on a continuous basis also. With the help of a reasonable capacity of thermal storage unit (120), it is possible to run both the adsorption mode (150) and the desorption mode (160) throughout the day and the night.

FIG. 3 In one embodiment, the present invention relates to a desiccant-based and a solar thermal-based atmospheric water generator system, wherein the desiccant unit (130) is configured in such a way that the adsorption mode (150) and the desorption mode (160) occur in a periodic manner making the system generate the freshwater (205) in batches. During the adsorption mode (150), the humidity in the atmospheric air is captured over the desiccant material (131). During the desorption mode (160), the captured humidity is recovered as freshwater (205) in the condenser unit (140).

The solar heat unit (110) is configured to heat up the heat transfer fluid (111) and supply the heat transfer fluid (111) to the thermal storage unit (120) for facilitating the storage of heat. The thermal storage unit (120) is configured to be in fluidic communication between the solar heat unit (110) and the desiccant unit (130). The thermal storage unit (120) comprises the hot storage unit (121) and the cold storage unit (122). The desiccant unit (130) is configured to comprise of the desiccant material (131), a desiccant holder (134) and a desiccant heating element (135). The desiccant holder (134) is configured to provide packing to the desiccant material (131). The desiccant holder (134) also facilitates the holding of desiccant material (131). The desiccant heating element (135) receives the hot heat transfer fluid (112) heated using the solar heat unit (110). The desiccant heating elements are further configured to provide heat to the desiccant elements. Both the adsorption mode (150) and the desorption mode (160) occur in the desiccant unit (120). The adsorption mode (150) and the desorption mode (160) occur in a periodic manner in the desiccant unit (130). During the adsorption mode (150), the desiccant unit (130) is brought in communication with the atmospheric air (201) using actuating elements wherein a part of humidity in the atmospheric air (201) is captured over the desiccant material (131). Once the desiccant material (131) is saturated with the water vapor content during the adsorption mode (150), then the fluidic communication between the desiccant unit (130) and the atmospheric air (201) is discontinued and this marks the onset of the desorption mode (160). During the desorption mode (160), the desiccant unit (130) is brought in the fluidic communication with the condenser unit (140). During the desorption mode (160), the desiccant unit (130) is further brought in the fluidic communication with the hot heat transfer fluid (112). The hot heat transfer fluid (112) during the desorption mode is supplied to the desiccant heating element (135) wherein it gets cooled down and is then transferred to the cold storage unit (122) to be later heated by the solar heat unit (110). The water vapor is released during the desorption mode (160) and condensed in the condenser unit (140) and return air (204) is circulated back to the desorption section wherein the return air (204) mixes with the newly formed water vapor in the desorption section and again is fed to the condenser unit (140) completing a closed loop. Once the desiccant material (131) has desorbed most of the water vapour, the fluidic communication between the desiccant unit (130), the condenser unit (140), and the thermal storage unit (120) is discontinued. This marks the onset of an adsorption mode (150) wherein the desiccant unit (130) is brought back to be in fluidic communication with the atmospheric air (201). The use of solid desiccant is more favorable with the said system configuration as the desiccant material (131) needs to be stationed in one location and cannot be moved easily into the different sections of the system. The adsorption mode (150) and the desorption mode (160) are run one after the other, thus making the system produce freshwater (205) during the desorption mode (160).

In one embodiment of the system, the desiccant heating element (135) in the desiccant unit (130) comprises a plurality of hollow circular tubes configured to carry the heat transfer fluid (111). The desiccant holder (134) comprises a substrate or a tray. The desiccant material (131) and the desiccant heating elements (135) are chemically or mechanically or thermally bonded to the desiccant holder (134) such but not limited to the substrate in order to minimize thermal resistance between the desiccant heating element (135) and the desiccant material (131).

In one embodiment of the system, the desiccant heating element (135) in the desiccant unit (130) comprises a plurality of hollow circular tubes configured to carry the heat transfer fluid 111. The walls of the desiccant unit (130) are configured to act as desiccant holder (140) as well. The desiccant heating element (135) is surrounded by the desiccant material (131).

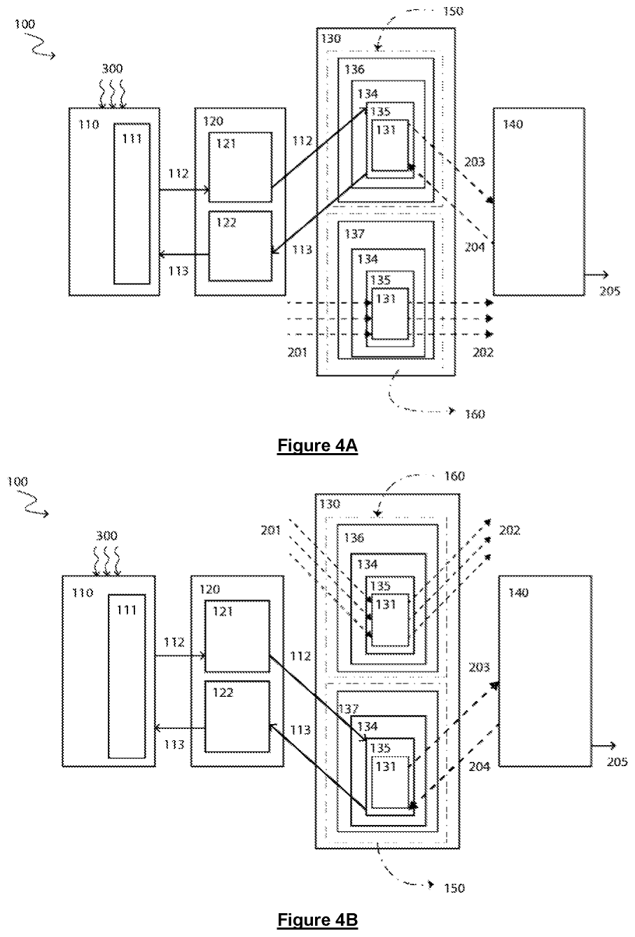

FIG. 4 In one embodiment, the present invention relates to a desiccant-based and a solar thermal-based atmospheric water generator system, wherein there is a plurality of desiccant units (136), (137) in order to ensure that the desorption mode (160) is carried out through the day and the night. This would ensure capacity utilization of the condenser unit (140) to be near 100% instead of 50%. In such an embodiment, a first desiccant unit (136) and a second desiccant (137) unit are in fluidic communication with a common condenser unit (140). The adsorption mode (150) and the desorption mode 160 in the first desiccant unit 136 and the second desiccant unit 137 are conducted in such a way that both the adsorption mode 150 and the desorption mode (160) keep happening in a continuous way in either the first desiccant unit (136) or the second desiccant unit (137).

The solar heat unit (110) is configured to heat up the heat transfer fluid (111) and supply the hot heat transfer fluid (112) to the thermal storage unit (120) for facilitating the storage of heat. The thermal storage unit (120) is configured to be in fluidic communication between the solar heat unit (110) and the desiccant material (130). The thermal storage unit (120) comprises the hot storage unit (121) and the cold storage unit (122). The system is configured to comprise two desiccant units, namely, a first desiccant unit (136) and a second desiccant unit (137). Both the first desiccant unit (136) and the second desiccant unit (137) are configured to comprise the desiccant material (131), a desiccant holder (134) and a desiccant heating element (135). The desiccant holder (134) is configured to provide packing to the desiccant material (131). The desiccant holder (134) also facilitates the holding of desiccant material (131). The desiccant heating element (135) receives the hot heat transfer fluid (112) heated using the solar heat unit (110). The desiccant heating elements (135) are further configured to provide heat to the desiccant material (131). The system is configured in such a way that if the first desiccant unit (136) is undergoing the adsorption mode (150), then the second desiccant unit (137) is undergoing the desorption mode (160) and vice-versa. The adsorption mode (150) and the desorption mode (160) keep happening in either of the two desiccant units, the first desiccant unit (136), and the second desiccant unit (137). This way it is ensured that the freshwater (205) is produced through the day and the night when using solid desiccants. This is possible owing to the fact that the desorption mode (160) can be run in a continuous manner even when using solid desiccants. While the first desiccant unit (136) undergoes the adsorption mode (150), the second desiccant unit (137) undergoes the desorption mode (160). The first desiccant unit (136) is brought in communication with the atmospheric air (201) using actuating elements herein a part of humidity in the atmospheric air (201) is captured over the desiccant material (131). Once the desiccant material (131) in the first desiccant unit (136) is saturated with the water vapor content during the adsorption mode (150), then the fluidic communication between the first desiccant unit (136) and the atmospheric air (201) is discontinued and this marks the onset of the desorption mode (160). When the adsorption mode (150) was going on in the first desiccant unit (136), the desorption mode (160) was being carried out in the second desiccant unit (137). The second desiccant unit (137) is brought in the fluidic communication with the condenser unit (140). During the desorption mode (160), the second desiccant unit (137) is further brought in the fluidic communication with the hot heat transfer fluid (112). The hot heat transfer fluid (112) during the desorption mode (160) is supplied to the desiccant heating element (135) wherein it gets cooled down and is then transferred to the cold storage unit (122) to be later heated by the solar heat unit (110). The trapped air along with water vapor (203) is released during the desorption mode (160) and condensed in the condenser unit (140) and return air (204) is circulated back to the second desorption section wherein the return air (204) mixes with the newly formed water vapor during the desorption mode (160) in the second desiccant unit (137) and again is fed to the condenser unit (140) completing a closed loop. Once the desiccant material (131) in the second desiccant unit (137) has desorbed most of the humidity, the fluidic communication between the second desiccant unit, the condenser unit (140), and the hot heat transfer fluid (112) is discontinued. This marks the onset of the desorption mode (160) in the first desiccant unit (136) and the adsorption mode (150) in the second desiccant unit (137). This is continually repeated to produce water (205) throughout the day and the night. While the system is configured to have two desiccant units (136),(137), only one condenser unit (140) is used to condense water vapor to produce freshwater. Depending upon which desiccant unit is undergoing the desorption mode (160), that particular desiccant unit is configured to be in fluidic communication with the thermal storage unit (120) or the solar heat unit (110) along with maintaining a fluidic communication with the condenser unit (140). The system revealed in this embodiment ensures that the capacity utilization factor of the condenser unit is near 100% while producing water from the atmospheric air (201) throughout the day and the night using the thermal storage unit (120) and solid desiccants.

FIG. 13 shows a method (1300) of generating water from air using solar energy according to one embodiment of the present invention.

The figure shows a method (1300) of generating water from air using solar energy, the method comprising: receiving, by a solar heat unit (110), a solar radiation during solar hours and converting the received solar radiation into heat (1310), receiving, by a thermal storage unit (120), the heat from the solar heat unit during solar hours and storing the received heat (1320), receiving, by a desiccant unit (130), the heat from the thermal storage unit or the solar heat unit, where the desiccant unit (130) comprises a desiccant material which undergo an adsorption mode (150) to adsorb air from the atmosphere and a desorption mode (160) to recover water vapor from humidity in adsorbed air (1330) and receiving, by a condenser unit (140), the water vapour and facilitating condensation of water vapor and generating fresh water (1340), facilitating a fluidic communication between the solar heat unit (110) and the desiccant unit (130).

The method wherein in the step storing the received heat by the thermal storage unit (120) comprises facilitating a provision to store heat in the thermal storage unit (120) for durations ranging from minutes to hours. The method comprises facilitating water generation in the non-solar hours by providing heat from the thermal storage unit (120) to the desiccant unit (130).

The method wherein in the step of the facilitating condensation of water vapor by the condenser unit (140) comprises facilitating the provision of heat radiation from the condenser unit (140) to the atmospheric surroundings using fins.

In one embodiment, the method comprises establishing and breaking the fluidic communication between the desiccant unit (130), atmospheric air (201), and the condensing unit (140) using at least one actuating element (500).

In one embodiment, the method comprises facilitating fluidic communication between the desiccant material (131) and the atmospheric air (201) and wherein in the desorption mode (160), the method comprises facilitating fluidic communication between the desiccant material (131) and the condenser unit (140).

In one embodiment, the method comprises facilitating the adsorption section 132 for performing the adsorption mode (150) and a desorption section (133) for performing the desorption mode (160), wherein the adsorption mode (150) and the desorption mode (160) to occur in two different sections of the desiccant unit (130), namely, an adsorption section (131) and a desorption section (132), wherein the adsorption section (131) is in the fluidic communication with the atmospheric air (201) and the desorption section (132) is sealed from the atmospheric air (201) and is in fluidic communication with the condenser unit (140).

In one embodiment, the method comprises facilitating the desiccant unit (130) to undergo the adsorption mode (150) and the desorption mode (160) in a periodic manner, making the atmospheric water generator system generate water batch-wise.

In one embodiment, the method comprises performing a simultaneous operation of the adsorption mode (150) and the desorption mode (160) in the desiccant unit (130) in a continuous manner.

The desiccant material (131) is a solid or liquid substance to adsorb atmospheric water vapor selected from a group of solid or liquid configurations of Silica-gel, calcium chloride, activated carbon, zeolites, hydrogels, glycols, and metal-organic frameworks.

In one embodiment, the method comprises facilitating receiving and storing of heat in a heat transfer fluid (111).

In one embodiment, the method comprises facilitating the incorporation of a hot storage unit (121) and a cold storage unit (122) in the thermal storage unit (120).

In one embodiment, the method comprises facilitating a forced circulation of atmospheric air (201) across the desiccant material (131) in the desiccant unit (130) using at least one fan (510).

In one embodiment, the method comprises facilitating a provision for one or more valves (500) to establish and break the fluidic communication between the solar heat unit (110), the thermal storage unit (120), the desiccant unit (130), and the condenser unit (140).

In one embodiment, the method comprises facilitating electricity using a plurality of solar photovoltaic cells (700) and a battery storage (701).

### REFERENCE NUMERALS

100—System; 110—Solar heat unit; 111—Heat transfer fluid; 112—Hot Heat transfer fluid; 113—Cold Heat transfer fluid; 115—Reflective element; 120—Thermal storage unit; 121—Hot storage unit; 122—Cold storage unit; 130—Desiccant unit; 131—Desiccant material; 132—Adsorption unit; 133—Desorption unit; 134—Desiccant Holder; 135—Desiccant Heating element; 136—First desiccant unit; 137—Second desiccant unit; 140—Condenser unit; 150—Adsorption process/mode; 160—Desorption process/mode; 201—Atmospheric air; 202—Dehumidified air; 203—Trapped air with water vapour; 204—Return air; 205—Fresh water; 210—Collection tank; 300—Solar radiation; 400—Mineralising unit; 401—Mineralising unit; 500—Valve/fluid controller; 510—Fans; 520—Pumps; 600—Valve/fluid controller; 700—Photovoltaic cells; Battery Storage—701

FIGS. 1-13 are merely representational and are not drawn to scale. Certain portions thereof may be exaggerated, while others may be minimized. FIGS. 1-13 illustrate various embodiments of the invention that can be understood and appropriately carried out by those of ordinary skill in the art.

In the foregoing detailed description of embodiments of the invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the detailed description of embodiments of the invention, with each claim standing on its own as a separate embodiment.

It is understood that the above description is intended to be illustrative, and not restrictive. It is intended to cover all alternatives, modifications and equivalents as may be included within the spirit and scope of the invention as defined in the appended claims. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Those skilled in this technology can make various alterations and modifications without departing from the scope and spirit of the invention. Therefore, the scope of the invention shall be defined and protected by the following claims and their equivalents.

1.-35. (canceled)

36. An atmospheric water generator system comprising:
a solar heat unit configured to receive solar radiation during solar hours and convert the received solar radiation into heat;
a thermal storage unit configured to receive the heat from the solar heat unit during solar hours and store the received heat;
a desiccant unit comprising a desiccant material, and configured to receive the heat from the thermal storage unit or the solar heat unit, wherein the desiccant unit is configured to undergo an adsorption mode to adsorb air from the atmosphere and a desorption mode to recover water vapor from the desiccant material; and
a condenser unit configured to receive and facilitate condensation of water vapor and generate fresh water; and
wherein the solar heat unit and the desiccant unit are in fluidic communication with each other.

37. The system as claimed in claim 36, wherein the thermal storage unit is sized to store heat for durations ranging from minutes to hours and configured to provide heat to the desiccant unit during the solar hours and non-solar hours for facilitating water generation.

38. The system as claimed in claim 36, wherein the thermal storage unit may comprise of a hot storage unit and a cold storage unit.

39. The system as claimed in claim 36, wherein the condenser unit is provided with fins to provide heat transfer area for transferring heat from the trapped air with water vapor to atmospheric air, wherein the condenser unit is actively or passively cooled.

40. The system as claimed in claim 36, wherein the desiccant unit comprises at least one actuated element which facilitates establishing and breaking the fluidic communication of the desiccant unit with the atmospheric air.

41. The system as claimed in claim 36, wherein the desiccant unit further comprises at least one fan for facilitating forced convection across desiccant material.

42. The system as claimed in claim 36, wherein the desiccant unit comprises an adsorption section for performing the adsorption mode and a desorption section for performing the desorption mode.

43. The system as claimed in claim 36, wherein the adsorption section is in the fluidic communication with the atmospheric air and the desorption section is sealed from the atmospheric air and is in fluidic communication with the condenser unit.

44. The system as claimed in claim 36, wherein the desiccant unit is configured to facilitate a simultaneous operation of the adsorption mode and the desorption mode in a continuous manner.

45. The system as claimed in claim 36, wherein the desiccant unit undergoes the adsorption mode and the desorption mode in a periodic manner, making the atmospheric water generator system generate water batch-wise.

46. The system as claimed in claim 36, wherein the desiccant material is a solid or liquid substance to adsorb atmospheric water vapor, selected from a group consisting of but not limited to Silica-gel, calcium chloride, activated carbon, zeolites, hydrogels, glycols, and metal-organic frameworks.

47. The system as claimed in claim 36, wherein the solar heat unit comprises flat plate solar collectors or evacuated tube collectors for capturing solar radiation.

48. The system as claimed in claim 36, wherein the solar heat unit further comprises a reflective element to capture more solar radiation.

49. The system as claimed in claim 36, wherein the system comprises a heat transfer fluid used to collect the heat from solar radiation in a solar heat unit and is stored in the thermal storage unit, wherein the heat transfer fluid transfers the heat to the desiccant material in the desiccant unit.

50. The system as claimed in claim 36, wherein the system further comprises one or more valves to establish and break the fluidic communication between the solar heat unit, the thermal storage unit, the desiccant unit and the condenser unit.

51. The system as claimed in claim 36, wherein the system further comprises solar photovoltaic cells and battery storage to supply electricity to the system.

52. A method of generating water from air using solar energy, the method comprising:
receiving, by a solar heat unit, a solar radiation during solar hours and converting the received solar radiation into heat;
receiving, by a thermal storage unit, the heat from the solar heat unit during solar hours and storing the received heat;
receiving, by a desiccant unit, the heat from the thermal storage unit or the solar heat unit, where the desiccant unit comprises a desiccant material which undergo an adsorption mode to adsorb air from the atmosphere and a desorption mode to recover water vapor from humidity in adsorbed air;
receiving, by a condenser unit, the water vapor and facilitating condensation of water vapor and generating fresh water; and
facilitating a fluidic communication between the solar heat unit and the desiccant unit.

53. The method as claimed in claim 52, wherein in the step storing the received heat by the thermal storage unit, wherein the method comprises facilitating the incorporation of a hot storage unit and a cold storage unit, wherein the method comprises facilitating a provision to store heat in the thermal storage unit for durations ranging from minutes to hours, wherein the method comprises facilitating water generation in the non-solar hours by providing heat from the thermal storage unit to the desiccant unit via the heat transfer fluid.

54. The method as claimed in claim 52, wherein, the method comprises facilitating the desiccant unit to undergo the adsorption mode and the desorption mode either in periodic manner, making the atmospheric water generator system generate water batch-wise or performing simultaneous operation of the adsorption mode and the desorption mode in the desiccant unit in a continuous manner.

55. The method as claimed in claim 52, wherein the method comprises facilitating electricity using a plurality of solar photovoltaic cells and a battery storage.
